(19) United States
(12) Patent Application Publication
(10) Pub. No.: US 2014/0270704 A1
(43) Pub. Date: Sep. 18, 2014

(54) SHOW NUMBER OF SECONDS BEFORE PROGRAM RESTART

(71) Applicant: ECHOSTAR TECHNOLOGIES L.L.C., Englewood, CO (US)

(72) Inventor: Sagar Zaveri, Highlands Ranch, CO (US)

(73) Assignee: ECHOSTAR TECHNOLOGIES L.L.C., Englewood, CO (US)

(21) Appl. No.: 13/797,582

(22) Filed: Mar. 12, 2013

(51) Int. Cl. H04N 5/91

(52) U.S. Cl. CPC H04N 5/91
USPC 386/248

(57) ABSTRACT

Provided are methods and apparatus to display a timer that counts down the time remaining in an interstitial of a recorded program stream before a next segment of the program content in the recorded program stream starts. In one embodiment, the interstitial contains at least one advertisement and the timer is displayed when the at least one advertisement is presented on a display device. The timer count is based on the calculated duration of the interstitial in the recorded program stream.

### BACKGROUND

1. Technical Field

This disclosure is directed to the display of a timer on a display device. In particular, a timer is provided for display to viewers during advertisements, teasers and/or miscellaneous content that are displayed between segments of a program content, the timer reflecting the number of minutes and/or seconds before the next segment of the program content starts.

2. Description of the Related Art

Generally, viewers of broadcast programs prefer to watch program contents free of advertisements. Certain exceptions may apply, of course, such as the highly anticipated and hyped advertisements during the Super Bowl. Because content providers rely on revenues from advertisers, it is reasonable to expect that advertisements will remain part of the viewing experience for a foreseeable future.

When viewing a recorded program content, a viewer has the option to skip the advertisements by manually fast-forwarding the recorded program content. This carries the risk of fast-forwarding too far, in which case, some rewinding of the recording may be necessary. Certain digital video recorders (DVR) have made it easier for the viewers to skip the advertisements by providing the viewer with an option to enable the DVR to automatically skip the advertisements during viewing of the recording. When the option is enabled, no manual fast forwarding or rewinding by the viewer is necessary; the recording is brought automatically from the end of one segment to the beginning of the next segment of the program content. U.S. Pat. No. 8,165,451 to Casagrande discloses a method and apparatus for determining the location of interstitials within a video stream, therefore when the interstitials contain advertisements, a DVR is able to automatically skip all advertisements.

This feature has caused much negative reaction from the content providers, putting pressure on the service provider to offer alternatives.

### BRIEF SUMMARY

Methods and apparatus for displaying a timer counting down the time to the next segment of a recorded program content while an advertisement is being displayed are provided.

In accordance with one embodiment of the present disclosure, a method for presenting a visual timer during an advertisement in a recorded program stream is provided. A client device records a program stream that includes at least two segments of a program content and at least one segment that is void of the program content. The client device also receives data associated with the program stream and uses this data to calculate the duration of the segment that is void of the program content. When the recorded program stream is selected for viewing on a display device, the client device sends the calculated duration to be displayed as a timer on the display device. In one aspect of the embodiment, the segment void of the program content includes an advertisement, and the client device causes the display device to show the duration as a timer when the advertisement is displayed. In the preferred embodiment, the timer counts down the time remaining in the advertisement.

In accordance with another embodiment of the present disclosure, a client device sends a request to a service provider for auxiliary data associated with a preferred program content. The client device receives and records a program stream that contains at least two segments of the preferred program content and at least one segment that is void of the preferred program content in storage. The segment void of the preferred program content may include one or more advertisements. In response to its request, the client device also receives the auxiliary data associated with the preferred program content. The client device proceeds to use the auxiliary data to calculate the duration of the segment void of the preferred program content in the recorded program stream. In one aspect of the embodiment, to calculate the duration of the segment void of the preferred program content, the client device uses the auxiliary data to identify the locations of the at least two segments of the preferred program content and uses these locations to identify at least one boundary of the segment void of the preferred program content. When the recorded program stream is selected for presentation on a display device, the client device sends the calculated duration with the program stream, and causes the display device to display the duration to the user. In another aspect of the embodiment, the interstitial contains one or more advertisements, and the display device presents the duration as a timer that counts down the time remaining for the advertisements until the next segment of the preferred program content starts.

### BRIEF DESCRIPTION OF THE SEVERAL VIEWS OF THE DRAWINGS

FIG. 1 illustrates an exemplary entertainment system in which an embodiment of the present disclosure is implemented.

FIG. 2 illustrates an exemplary block diagram of a client device in which an embodiment of the present disclosure is implemented.

FIG. 3 illustrates an exemplary process for displaying a timer during a presentation of an advertisement in a recorded program stream.

FIG. 4 illustrates an alternative process for displaying a timer during a presentation of an advertisement in a recorded program stream.

FIG. 5A illustrates an exemplary embodiment of the present disclosure as displayed on a display device.

FIG. 5B illustrates another exemplary embodiment of the present disclosure as displayed on a display device.

### DETAILED DESCRIPTION

The various embodiments described herein generally provide devices, systems, and method to facilitate the reception, processing and outputting a timer indicating the remaining time of a presented advertisement in a recorded program stream.

For the purpose of describing the embodiments in this section, a transmission signal is defined as the signal received from a service provider. A transmission signal contains several video/audio streams and data. Data transmitted in one transmission signal is associated with at least one video/audio stream that may be included in the same transmission signal, in a previous transmission signal, or in a subsequent transmission signal. For the purpose of providing an example, an MPEG transport stream is used. An MPEG transport stream is a standard transmission (and storage) format of video, audio, and data or information associated with the video and audio. Packets of video/audio and data are multiplexed onto the stream. One transmission signal may carry video/audio streams of more than one program content, and one program content may be transmitted in one or more video/audio packets in the transport stream.

FIG. 1 illustrates an exemplary a distribution system 10 used to provide program contents to a user 12. The system 10 in FIG. 1 includes a client device 16 coupled to a display device 18 over a first cable 28, and a broadcast service provider 20 communicatively coupled to the client device via a communication network 30. The user 12 interacts with the client device 16 and with the display device 18 via a remote control 14. The client device 16 is preferably a content receiver with recording capability, such as a set top box, a Digital Video Recorder, or the like. The display device 18 is preferably a television, but other display devices such as monitors or projectors are also contemplated. The display device 18 may also be combined with the client device 16 as one device.

The first cable 28 is configured to carry a signal suitable for presentation of a program content on the display device 18. The first cable 28 therefore may be an analog cable, such as a composite video cable, S-video cable, or the like, or a digital cable, such as HDMI, DVI or the like.

The client device 16 in the system 10 receives a transmission signal from the broadcast service provider 20 via the communication network 30. The communication network 30 includes wired media, such as copper and fiber optics, and wireless media and their respective nodes. Examples of communication network 30 include an Internet protocol based computer network, a direct satellite broadcast network, a cable broadcast network, a telephony network, and the like. The communication network 30 is well known in the art and will not be discussed in detail in the present disclosure. In a preferred embodiment, the client device 16 is coupled to a direct satellite broadcast service provider via a direct satellite broadcast network. In one aspect of the preferred embodiment, the client device 16 is also coupled to the direct satellite broadcast service provider via an Internet protocol based computer network.

In an exemplary MPEG transmission stream, program contents are transmitted as packets; each packet carrying an identification code (PID). Packets associated with one program content carry the same PID, and in a preferred embodiment, the client device 16 is configured to extract the packets with the PID associated with a selected program content from the transmission signal. A collection of these extracted packets is used to generate a program stream to be recorded. Data included in a transmission signal may be used to assemble the packets into the program stream.

Each recorded program stream includes a plurality of segments of one program content separated by interstitials. An interstitial is defined for the purpose of this disclosure as a segment or period between two segments of a program content that does not contain any part of the program content. The content of the interstitials may include one or more advertisements, a teaser, a news flash or other video/audio that is not part of the program content. In one embodiment, the broadcast service provider 20 determines the content of each interstitial in the program stream. In other embodiments, the client device 16 determines the content of interstitials in the program stream.

The client device 16 is further configured to receive data associated with the program stream and to use this data to calculate the duration of the interstitials based on its boundaries in the program stream. There are many techniques to identify the boundaries of interstitials in a program stream, for example, by using digital signal processing to first identify the locations of the segments containing program content, or by using segment descriptors in a metadata. These techniques are well known in the art and will not be discussed in detail in the present disclosure. In a preferred embodiment, the client device 16 receives a Presentation Time Stamp (PTS) in a metadata associated with the program stream, and uses this information to calculate the duration of each interstitial in the program stream. The PTS is well known in the art and is not discussed in detail in the present disclosure. The client device 16 may receive other types of data that can be used to calculate the duration of each of the interstitials in the program stream. The client device 16 saves the calculated duration of each interstitial in the recording storage and/or other memory location for subsequent retrieval.

When the recorded program stream is selected by the user 12 for presentation on the display device 18, the client device 16 sends the program stream to the display device 18 and the calculated duration of each interstitial in the program stream. The client device 16 may send multiple sub-durations of each interstitial when the interstitial contains one or more advertisements, each sub-duration representing the length of each advertisement. In some cases, the interstitial also contains teasers, station identification, or short news flashes, each with its own sub-duration. Preferably, the client device 16 sends the sum of all the sub-durations, or the duration of the interstitial itself.

When a segment of a program content in the program stream ends and an advertisement appears, a timer counting down the seconds until the next segment of the program content starts is displayed on the display device 18. The timer is preferably presented in the form of a number counting down in seconds and overlaid on the advertisement being displayed. The timer continues to be displayed as the contents of the interstitial are presented to the user 12. The user 12 is therefore informed of the remaining time before the next segment of the program content starts.

Frequently, there will be three or more advertisements between segments of a program content; there are three or more advertisements in an interstitial. For example, the interstitial may contain a thirty-second first advertisement, a one-minute second advertisement, and a one-minute third advertisement. The calculated duration of the interstitial is two and one-half minutes. In this example, the timer will show 2:30 at the beginning of the first advertisement. This will alert the viewers that there will be a total of two and one-half minutes remaining of advertisements before the next segment of the program content starts. The timer counts down the remaining time, and when the second advertisement begins, the timer shows 2:00, indicating that two minutes remains before the next segment of the program content starts. The time shown will be the remaining duration of the interstitial and it counts down as each of the three advertisements is presented.

In another example, the interstitial contains the three advertisements above, a five second teaser and a forty-five second news flash. The duration for this interstitial is calculated to be three minutes and twenty-five seconds. The timer then will show 3:25 when the first content of the interstitial is presented to the user, and counts down the remaining duration until the next segment of the program content starts, as subsequent contents of the interstitial are presented to the user.

In an alternative embodiment, the timer shows a duration of each individual content of the interstitial that is being presented. In the above example, when the first advertisement is presented to the user on the display device, the timer shows 0:30 as the time remaining for the first advertisement, when the second advertisement is presented to the user on the display device, the timer shows 1:00, and when the third advertisement is presented to the user on the display devices, the timer shows 1:00. Further, when the teaser is presented, a timer showing 0:05 is displayed, and when the news flash appears, a timer showing 0:25 is displayed. In this alternative embodiment, instead of indicating the remaining duration until the next segment of the program content starts, the timer is indicating the duration of each content in the interstitial and starting a new countdown for each content.

Knowing how long he has before the next segment of the program content starts, the user 12 may choose to fast forward the recording, in which case the displayed timer is shown as counting down the remaining time faster. The user 12 may also choose to pause the recording during the advertisement because he has to attend to another task and, based on the displayed timer, he knows he would not be able to come back in time for the next segment. In this case, the countdown timer also pauses and only continues the countdown when the user 12 instructs the client device 16 to resume the playback of the recorded program stream. If the user 12 wishes to rewind the advertisement, the timer adjusts the timing count accordingly to reflect the updated duration, adding the appropriate units to its count value.

In a preferred embodiment, the client device 16 does not provide the visual timer during a playback of an advertisement in a recorded program stream unless it is enabled to do so by the user 12 through a preference selection during a set up.

Turning now to FIG. 2, an exemplary block diagram of a client device 16 is shown to include a front end module 40, a recording module 42, a processing module 44, a memory module 46, a storage module 48 and a presentation module 50. Additional modules may be included in the client device 16. Each module may be implemented as a hardware, software, firmware or a combination thereof. A plurality of modules may be combined into one, and each module may be further broken down into submodules.

The front end module 40 is configured to receive transmission signals and other data via the communication network 30, and to receive commands from the user 12. The user 12 uses a remote control 14 to send commands to the client device 16 over a wireless interface. Preferably, the wireless interface is a radio frequency interface, although an infrared and other wireless interfaces are contemplated. Examples of a radio frequency interface include ZigBee, Wi-Fi, Bluetooth or the like.

In a preferred embodiment, transmission signals are received via at least one tuner (not shown) in the front end module 40, the commands from the user 12 are received via a receiver antenna (not shown), and other data are received via a wired network interface (not shown).

The front end module 40 is further configured to transmit a signal to the broadcast service provider 20 via the communication network 30; therefore in the preferred embodiment, the wired network interface is also configured to receive and transmit communication with the broadcast service provider 20.

The processing module 44 in FIG. 2 is coupled to the front end module 40 and is configured to process the transmission signals, to extract the video/audio streams and data streams associated with a program content of interest and combine them as a program stream for recording by the recording module 42. As previously discussed, the data stream may include an indication for synchronizing an audio stream to its associated video stream. A metadata stream is an example of a data stream that describes its associated video and/or audio stream of a program content with information about the program content and the length of each segment of the program content. Data streams associated with a program content of interest may be received in the same transmission signal that carry the video/audio stream of the program content of interest, or in different transmission signal, such as a transmission signal previously received or subsequently received.

The processing module 44 may also receive data associated with the video/audio streams of the program content of interest from the communication network 30 via the wired network interface.

The processing module 44 is further configured to calculate and store the duration of the interstitial based on the received data. Preferably, the calculated duration is in seconds. Other units of measurements are also contemplated.

The processing module 44 is also coupled to the memory module 46 that contains at least a nonvolatile device and a volatile device. The memory module 46 is configured to store instructions to be executed by the processing module 44. The memory module 46 is also configured to store data needed for the execution of the instructions. Examples of nonvolatile devices are Flash, EPROM, MRAM, FRAM, SRAM, solid state memory and the like. Examples of volatile devices are various types of DRAMs and the like. It is contemplated that some nonvolatile memory is integrated into the processing module 44.

The recording module 42 is coupled to the processing module 44 and the storage module 48. The recording module 42 is configured to store program streams in the storage module 48. The storage module 48 comprises at least one nonvolatile memory device, such as an optical drive, a solid state drive, or a hard drive. The recording module 42 is further configured to control access to the storage module 48 at least based on instructions from the processing module 44.

When the user 12, by using the remote control 14, selects a recorded program stream for presentation on the display device 18, the processing module 44 causes the recording module 42 to retrieve the program stream from the storage module 48 and sends the retrieved program stream and the calculated duration of the interstitials to the presentation module 50.

The display device 18 may only recognize a program stream of a certain format; therefore the presentation module 50 is configured to format the program stream so that it is suitable for presentation on the display device 18. Further, the presentation module 50 is also configured to render a visual object that displays a count of the calculated duration on the display device 18. In a preferred embodiment, the presentation module 50 causes a visual timer to be displayed while one or more contents of the interstitial, contents such as advertisements, teasers, news flash, station identification and the like, is being presented on the display device 18. The displayed visual timer in the preferred embodiment counts down the time remaining until another segment of the program content in the program stream starts again.

The metadata may be transmitted together with the program content segment or prior to transmission of the program content. Metadata may be stored in the server and delivered when requested by the system, either for recording or for live presentation.

FIG. 3 illustrates one exemplary process for displaying the duration of an interstitial in a program stream. The process illustrated in FIG. 3 is not exhaustive as there may be other operations in the process that, for brevity, are excluded. While the operations in FIG. 3 are depicted as being executed in a particular order, other orders of execution of two or more operations may be possible. The process includes receiving a transmission signal that includes a program content (operation 52), and receiving data associated with the program content (operation 54). The data may be a metadata received in the same transmission signal that includes the program content, or in a different transmission signal. The data may also be data received via a different medium. The data includes at least some information to identify the locations of the at least two segments of the program content in the recorded video stream. The process continues with recording the program stream of the program content in a storage (operation 56), the program stream having at least two segments of the program content and at least one interstitial containing one or more advertisements. Each interstitial may further contain a teaser, station identification, news flash, or other audio video content. The duration or length of each interstitial is calculated based on the received data (operation 58), preferably in the unit measurement of ‘seconds’. When the recorded program stream is selected for presentation on a display device (operation 60), an object renderable as a timer displaying the calculated duration of the interstitial is transmitted with the program stream to the display device (operation 62). When any one advertisement in the interstitial is displayed, the timer displaying the time remaining in the duration of the interstitial is displayed as an overlay on the advertisement (operation 64).

FIG. 4 illustrates another process for displaying the timer according to an alternative embodiment of the present disclosure. In the alternative embodiment, the data used to calculate the duration of an advertisement in a recorded program stream may be transmitted to a client device upon request by the client device. In this embodiment, a client device sends a request for an auxiliary data to the broadcast service provider (operation 66), the request identifying a preferred program content, and the auxiliary data being data to be used to calculate the duration of interstitials in a program stream of the preferred program content. The client device receives a transmission signal containing the preferred program content from the broadcast service provider (operation 68), and, in response to the request, receives the auxiliary data (operation 70). In the preferred embodiment, the client device receives the transmission signal from a satellite broadcast network, and the auxiliary data in the same transmission signal. The client device may also receive the auxiliary data via a different medium. The client device proceeds to record the program stream of the preferred program content in storage (operation 72) and uses the auxiliary data to calculate the duration of the interstitials in the recorded program stream (operation 74). When the recorded program stream is selected for presentation on a display device (operation 76), an object renderable as a timer displaying the calculated duration of an interstitial is transmitted with the program stream to the display device (operation 78). While a content of the interstitial, such as an advertisement, is displayed, the timer displaying the time remaining in the duration of the interstitial is also displayed as an overlay on the advertisement (operation 80). In one aspect of the embodiment, the client device 16 determines the preferred program content based on a monitored recording habit of the user.

In one aspect, the timer counts down each advertisement separately, starting with a new timer for each new advertisement and ending at zero when that advertisement is over. In this embodiment, the time shown indicates the duration to the end of the currently displayed advertisement and not the duration of the entire interstitial.

It is thus possible to obtain a timer value from header data in the advertisement and not from the program stream and program content. This would permit the time remaining in a particular advertisement to be displayed live, as part of a live data stream that has not been previously recorded. It may also be possible to use multiple advertisement headers and stitch together a total duration of two or more advertisements and display a timer at the start of a first advertisement that begins a countdown for the two or more advertisements that sequentially follow the first one.

FIG. 5A shows a timer 84 counting down the time remaining in the duration of an interstitial before the next segment of the program content starts while an advertisement 82 is being presented to the user. In this example, the time remaining before the program content starts again is sixty seconds, and the advertisement is a content of the interstitial. The timer 84 is displayed as an overlay over the advertisement 82. It is also contemplated, however, that the advertisement is presented in one region of the display while the timer is presented in a second region of the display.

FIG. 5B shows the timer 84 having advanced in its countdown and is showing that fifty-nine seconds remain before the next segment of the program content starts. In FIG. 5B, however, the timer 84 is displayed on a corner of the display screen. The timer 84 may be displayed on the lower right, upper right, or in any area on the screen in such a way that it does not block any relevant part of the advertisement.

The various embodiments described above can be combined to provide further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
recording a program stream including at least two segments of a program content and at least one interstitial, the at least one interstitial being a segment void of the program content;
receiving data associated with the program stream;
calculating a duration of the interstitial based on the received data;
generating an object renderable as a timer on a display device, the object indicating the duration of the interstitial;
receiving a command from a user to play the recorded program stream;
sending the object to the display device; and
causing the display device to show the timer displaying a timing count of the remaining duration of the interstitial.

2. The method as claimed in claim 1 further comprising:
receiving a transmission stream from a broadcast service provider, the transmission stream including the program content.

3. The method as claimed in claim 2, wherein receiving the data occurs concurrent to receiving the transmission stream.

4. The method as claimed in claim 2, wherein receiving the data occurs subsequent to receiving the transmission stream.

5. The method as claimed in claim 1, wherein calculating the duration of the interstitial comprises:
identifying locations of the at least two program content segments in the program stream based on the data; and
identifying at least one boundary of the at least one interstitial based on the locations of the at least two program content segments, and wherein the duration is calculated based on the identified locations of the at least two program content segments and the identified at least one boundary.

6. The method as claimed in claim 1, wherein the interstitial includes at least one advertisement, and wherein the display device is caused to show the timer while the at least one advertisement is being displayed.

7. The method as claimed in claim 6, wherein the timer is displayed as an overlay on the at least one advertisement.

8. The method as claimed in claim 6, wherein the timing count is a countdown of time remaining in the at least one advertisement until a second segment of the program content starts.

9. The method as claimed in claim 1, wherein the data is a metadata associated with the program content, the metadata including at least a Presentation Time Stamp.

10. The method as claimed in claim 1, wherein sending the object to the display device is concurrent to sending the at least one interstitial in the program stream to the display device.

11. The method as claimed in claim 1 wherein the program content is received over a first communication channel and the data is received over a second communication channel.

12. The method as claimed in claim 1 further comprising:
receiving, from the user, a selection to enable causing the display device to show the timer.

13. A method comprising:
sending a request to a broadcast service provider for auxiliary data associated with a preferred program content, the request identifying the preferred program content;
receiving a program stream including at least two segments of the preferred program content and at least one interstitial, the interstitial being void of the preferred program content;
recording the program stream;
receiving the auxiliary data in response to the request;
calculating a duration of the interstitial based on the auxiliary data;
generating an object renderable as a timer on a display device, the object indicating the duration of the interstitial;
receiving a command from a user to play the recorded program stream;
sending the object to the display device; and
causing the display device to show the timer displaying a timing count of the duration remaining.

14. The method as claimed in claim 13 further comprising:
monitoring a recording habit of the user; and
identifying the preferred program content from the monitored recording habit.

15. The method as claimed in claim 13 wherein the auxiliary data is included in a transmission stream received from the broadcast service provider.

16. The method as claimed in claim 13 wherein calculating the duration comprises:
identifying locations of the at least two segments of the preferred program content in the program stream based on the auxiliary data; and
identifying at least one boundary of the at least one interstitial based on the identified locations of the at least two segments of the preferred program content, and
wherein the duration is calculated based on the identified locations of the at least two segments and the identified at least one boundary.

17. The method as claimed in claim 13, wherein the interstitial includes at least one advertisement, and wherein the display device is caused to show the timer while the at least one advertisement is being displayed.

18. The method as claimed in claim 17, wherein the timing count is a countdown of time remaining in the at least one advertisement until a second segment of the program content starts.

19. The method as claimed in claim 17, wherein the timer is shown as an overlay on the advertisement.

20. A device comprising:
a storage module;
a front end module configured to
receive a transmission stream from a broadcast service provider, the transmission stream including a program content, and
receive an auxiliary data associated with the program content;
a recording module coupled to the storage module, the recording module configured to store a program stream in the storage module, the program stream including at least two segments of the program content and an interstitial, the interstitial being a segment void of the program content; and
a processing module coupled to the recording module, the processing module configured to
calculate a duration of the interstitial at least based on the auxiliary data;
generate an object renderable as a timer on a display device, the object indicating the duration of the interstitial; and
a presentation module configured to
output the stored program stream and the object to the display device, and
cause the display device to show the timer displaying a timing count of the duration of the interstitial.

21. The device as claimed in claim 20 wherein the interstitial includes an advertisement and the display device is caused to show the timer while the advertisement is being displayed.
